(19) United States
(12) Patent Application Publication
(10) Pub. No.: US 2026/0236670 A1
(43) Pub. Date: Aug. 13, 2026

(54) DATA CONVERSION SYSTEM AND METHOD

(71) Applicant: Trove Technologies, Inc., Palm Beach Gardens, FL (US)

(72) Inventor: Saurabh Hiten Nagrecha Thakkar, Fremont, CA (US)

(21) Appl. No.: 19/538,661

(22) Filed: Feb. 12, 2026

Related U.S. Application Data
(60) Provisional application No. 63/757,846, filed on Feb. 13, 2025.

(51) Int. Cl. G06F 40/166; G06F 9/54

(52) U.S. Cl. CPC G06F 40/166; G06F 9/547

(57) ABSTRACT

A method may include obtaining, via a user interface, data from a user. The data may be associated with a first format. The method may also include converting, using a conversion module, the data having the first format to standardized data having a second format. The conversion module may be trained using a first instruction set associated with the data and a second instruction set associated with the second format. The method may further include comparing the standardized data to requirements included in the second instruction set. The method may also include transmitting, via the user interface, a notification to the user in response to detecting a difference between the standardized data and the requirements in the second instruction set. The notification may include at least a description of the difference and a recommendation of a solution to the difference.

### CROSS REFERENCE TO RELATED APPLICATIONS

This U.S. Patent Application claims priority to U.S. Provisional Patent Application No. 63/757,846, titled “DATA CONVERSION SYSTEM AND METHOD,” and filed on February 13, 2025, the disclosure of which is hereby incorporated by reference in its entirety.

### TECHNICAL FIELD

This disclosure generally relates to a data conversion system, and more specifically, to a payment manager conversion system.

### BACKGROUND

Unless otherwise indicated herein, the materials described herein are not prior art to the claims in the present application and are not admitted to be prior art by inclusion in this section.

Some data and/or data files may include many entries which may also be visually and/or technically complex. As such, management of such files can be difficult and/or may use many resources, including personnel. In instances in which the files need to be converted from a first format to a second format, the difficulty of the conversion process may be compounded by the complexity of the files in the first format and the specifications of the second format to which the files are converted, which may further increase the resource demands.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, a method may include obtaining data from a user. The data may be obtained via a user interface and the data may be associated with a first format. The method may also include converting the data having the first format to standardized data having the second format using a conversion module. The conversion module may be trained using a first instruction set associated with the data and a second instruction set associated with the second format. The method may further include comparing the standardized data to requirements included in the second instruction set. The method may also include transmitting a notification to the user via the user interface. The notification may include at least a description of the difference and a recommendation of a solution to the difference. The notification may be transmitted in response to detecting a difference between the standardized data and the requirements in the second instruction set.

In another embodiment, a computing system may include a processor and a memory. The memory may store instructions that, when executed by the processor, may cause the computing system to obtain, via a user interface, data from a user. The data may be associated with a first format. The computing system may also convert, using a conversion module, the data having the first format to standardized data having a second format. The conversion module may be trained using a first instruction set associated with the data and a second instruction set associated with the second format. The computing system may further compare the standardized data to requirements included in the second instruction set. The computing system may also transmit, via the user interface, a notification to the user in response to detecting a difference between the standardized data and the requirements in the second instruction set. The notification may include at least a description of the difference and a recommendation of a solution to the difference.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates a block diagram of an example system for data conversion in a payment manager system; and

FIG. 2 illustrates an example computing device.

### DETAILED DESCRIPTION

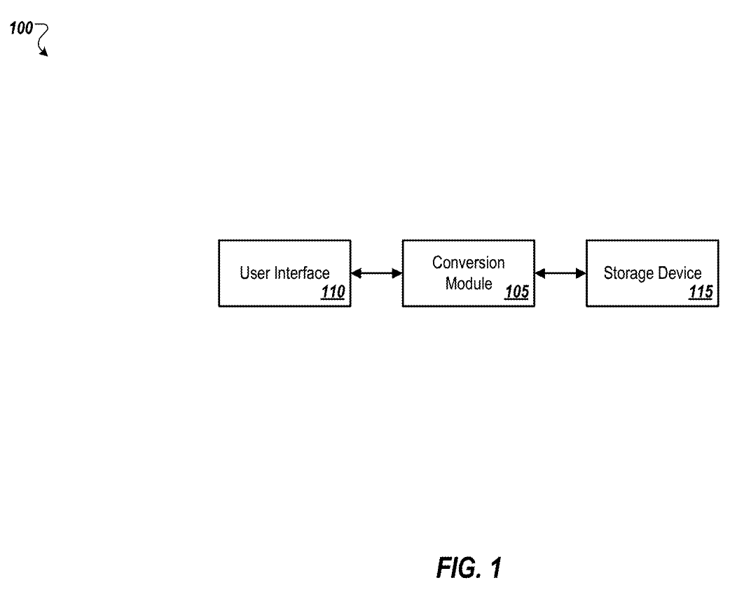

In some instances, a data conversion system 100 may include conversion module 105, a user interface 110, and a storage device 115. An exemplary aspect of a data conversion system 100 is shown in FIG. 1. The data conversion system 100 may be operable to autonomously convert a set of data from a first format to a second format in view of one or more instructions obtained by the data conversion system 100.

In some instances, the data conversion system 100 may obtain data to be converted from a first format to a second format. In some instances, the set of data may be obtained from a user via the user interface 110. For example, a user may select a data file and upload the set of data to the data conversion system 100. Alternatively, or additionally, the set of data may be obtained from the storage device 115. In some instances, the user may utilize an application programming interface (API) to directly interface with the data conversion system 100 to transfer data to the data conversion system 100, such that the user interface 110 may be bypassed. Alternatively, or additionally, the data may be obtained by the data conversion system 100 using a Remote Procedure Call (RPC) protocol, such as Google Remote Procedure Call (gRPC).

The data conversion system 100 may use the conversion module 105 to convert a set of data from a first format to a second format. In some instances, the conversion module 105 may perform a conversion of the set of data in view of first instructions that may be associated with the first format and/or in view of second instructions that may be associated with the second format. For example, the set of data (e.g., invoices) may be formatted according to a first particular format in view of a first set of instructions (e.g., instructions associated with a first bank, a financial system such as SWIFT, one or more stock exchanges such as the New York Stock Exchange, etc.) and the conversion module 105 may be operable to convert the set of data from the first particular format to a second particular format, where the second particular format may include a second set of instructions (e.g., instructions associated with a second bank).

The instructions may describe aspects associated with the formatting of a set of data, which may include, but not be limited to, an arrangement of elements within the set of data (e.g., a placement of elements of the set of data relative to one another), specification of optional data and/or required data, expected ranges of values, data types and/or the arrangement of the data types, etc. The elements of the set of data may include one or more entries in the set of data that, combined with other elements, form the set of data. For example, in instances in which multiple invoices is the set of data, an element within the set of data may be a particular invoice. Described another way, a set of data may be an array-like structure where the rows in the set of data may correspond to particular invoices and the columns in the set of data may include various data associated with the invoices, such as date, account number, amount, currency, and/or other values.

In some instances, the conversion module 105 may be operable to identify the elements and/or the format of the elements within the set of data based on instructions. In some instances, the instructions may be individually associated with an entity associated with the set of data. For example, in instances in which the set of data is a collection of invoices, the instructions may be rules and/or a predetermined structure as determined by a particular bank associated with the set of data. In some instances, the instructions may be in various file formats, which may include one or more of portable document format (PDF), JavaScript Object Notation (JSON), comma-separated values (CSV), word document, and/or file formats. In some instances, the instructions may define a delimiter to separate the elements and/or the values included in the elements within the set of data. Examples to the methods described herein utilize data and/or instructions that may be associated with a bank. However, data and/or instructions associated with other organizations and/or financial institutions may be utilized with the methods described herein. For example, data and/or instructions that may be used with the methods and/or processes described herein may be associated with various organizations and/or financial institutions such as, but not limited to, financial messaging network such as the SWIFT network, stock exchanges such as the New York Stock Exchange, etc.

In some instances, the conversion module 105 may utilize one or more large language models (LLMs) to read the instructions obtained in the various file formats. LLMs are a type of artificial intelligence utilizing machine learning for natural language processing. Alternatively, or additionally, the conversion module 105 may utilize the one or more LLMs to ingest information associated with the set of data and/or the instructions associated with the set of data, as described herein. In some instances, the LLMs may be available LLMs which may be provided by a third party. For example, the conversion module 105 may utilize LLMs such as provided by Google LLC under the trademark Gemini™. Alternatively, or additionally, one or more LLMs may be developed with respect to the individual instructions associated with the set of data. For example, a first LLM may be utilized relative to first instructions, a second LLM may be utilized relative to second instructions, and so forth. The one or more LLMs that may be developed for use by the conversion module 105 may be trained and/or tuned using various machine learning techniques, such as instruction-tuning, fine-tuning, reinforcement learning from human feedback (RLHF), and/or other various techniques. In other aspects, artificial intelligence other than or in addition to LLMs can be used in the conversion module 105.

In some instances, the conversion module 105 may be operable to ingest information regarding the set of data based on the instructions associated therewith. Based on the ingested information, the conversion module 105 may be operable to perform a conversion to the set of data from a first format associated with the instructions, to a second format, such as a standardized format. For example, in instances in which the set of data includes invoices and the first format is associated with a particular bank, the standardized format (e.g., the second format to which the conversion module 105 may convert the set of data) may be the Bank Administration Institute (BAI) file format. Examples provided herein may reference invoices and/or the BAI file format, but it is understood that many other implementations of the methods described may be used. In particular, in instances in which there is data conversion performed relative to a rigid file structure (e.g., the BAI file format or other standardized specifications), the conversion module 105 may be utilized to perform similar operations as described herein.

In some instances, the standardized format may be a complex format, including multiple requirements for the data to conform thereto. For example, the BAI file format may include specifications that direct the arrangement of invoice data (e.g., such as individual entries per row), elements that may be included in the data, and/or context for what the elements may refer to. In some instances, when transactions are performed using the standardized format, a failure to adhere to the standardized format may result in a rejection of the file. For example, a BAI file submitted to a bank that includes a mistake in an expected value, or a mistake in a number of elements included in a single line item, may cause the entire BAI file to be rejected. Alternatively, or additionally, in instances in which a file is rejected for failure to adhere to associated instructions (e.g., a BAI file in view of the BAI file format), a notification as to the one or more reasons for rejection may not be provided. As such, it may be difficult to determine corrections to make to the file having the standardized format to ensure the file conforms to the requirements.

In some instances, the conversion module 105 may be operable to obtain a file arranged according to a first instruction set (e.g., as described herein, such as relative to a particular bank) and the conversion module 105 may be operable to convert the file to be arranged relative to the standardized format. In some instances, the conversion module 105 may perform the conversion upon request, such as from a user. For example, a user may upload a file (that may be arranged according to the first instruction set) and the conversion module 105 may convert the file to be arranged according to the standardized format. For example, a particular invoice file may be arranged according to a particular bank instruction set and in response to a user uploading the particular invoice file, the conversion module 105 may be operable to convert the particular invoice file to the BAI file format, according to the corresponding standardized instruction set.

Alternatively, or additionally, the conversion module 105 may be operable to automatically perform updates to a file. For example, in instances in which the conversion module 105 has access to a previously converted file (e.g., the particular invoice file converted to the BAI file format), in response to an update of the standardized instructions, the conversion module 105 may automatically update the previously converted file to conform to the updated standardized instructions. For example, the conversion module 105 may implement a versioned schema change command, which may automatically update a file in view of one or more changes to associated instructions. In some instances, the conversion module 105 may be operable to detect that a change has been made to the standardized instructions and may present the option to the user to update the file in view of the changed standardized instructions. In response to the user confirming they would like to make the changes, the conversion module 105 may update the file in view of the changed standardized instructions.

In some instances, the conversion module 105 may be operable to validate an obtained file relative to a specification, such as the standardized specification described herein. In some instances, the obtained file may be arranged relative to the standardized specification to which the conversion module 105 may compare the obtained file to the standardized specification. In instances in which the conversion module 105 determines an issue and/or potential error in the obtained file (which may result in a rejection of the obtained file, as described herein), the conversion module 105 may communicate a notification to the user. In some instances, a manual review of the obtained file may take multiple months (e.g., six months) or longer, whereas the review of the obtained file by the conversion module 105 may be performed in less than a day. In such instances, the conversion module 105 may be operable to provide feedback regarding a likelihood or rejection of the obtained file in a much shorter timeframe relative to feedback from manual review of the obtained file. The notification may alert the user that a change may be needed to the obtained file and/or the notification may include a suggested edit. In some instances, the user may interact with the conversion module 105 to approve a suggested edit by the conversion module 105, and in response to a confirmation by the user, the conversion module 105 may implement the suggested edit to the obtained file.

The conversion module 105 may compare various elements of the obtained file to the standardized specification to determine if any errors and/or issues may be present in the obtained file. Alternatively, or additionally, the conversion module 105 may be operable to detect unusual and/or unexpected activity associated with the obtained file. For example, the conversion module 105 may have access to previous files associated with a user and the conversion module 105 may be operable to compare historical elements and/or expected elements to the elements in the obtained file and in response to the elements in the obtained file satisfying a threshold relative to the expected elements, the conversion module 105 may provide a notification to the user of the difference. An example may include a user having invoices that may be $10,000 or less and the conversion module 105 determines an invoice in the obtained file includes at least one invoice for more than $100,000 (or some predetermined threshold, which may be based on amount different, percent different, etc.). The conversion module 105 may thereafter communicate a notification to the user. In another example, a particular user may have historical data that is in USD and the conversion module 105 may determine that a particular element in the obtained file is EUR, and the conversion module 105 may communicate a notification to the user.

In some instances, the conversion module 105 may include one or more agents encoded therein. An agent, with respect to the conversion module 105, may be specialized to handle differences that may arise as part of the conversion process. For example, a first agent may be implemented for currencies that use comma separators (e.g., one thousand denoted as 1,000) and a second agent may be implemented for currencies that use period separators (e.g., one thousand denoted as 1.000). Many various agents may be implemented by the conversion module 105, and in some instances, more than one agent may be utilized at a time. In some instances, the agents may be based on an institution associated with the conversion (e.g., a particular bank), based on a localization and/or geographic region (e.g., a first agent for North America and a second agent for Europe), based on applicable regulations (e.g., a first agent for CCPA regulations and a second agent for GDPR regulations), based on compliance (e.g., a first agent for the US Bank Secrecy Act (BSA), a second agent for the Canadian Financial Transactions and Reports Analysis Centre (FINTRAC), a third agent for the EU Anti-money Laundering Directive (AMLD), etc.), fraud and/or anomaly detectors, and/or other nuanced differences between various stakeholders in the conversion process.

In some instances, the implementation of the data conversion system 100 and/or the conversion module 105 may be on a local computing device, a cloud computing device, and/or a hybrid of local computing systems. For example, in a first implementation, the data conversion system 100 may be operated on a local computing system and in a second implementation, the data conversion system 100 may be operated on a multi-cloud system where portions of the data conversion system 100 may be disposed in different networked computing systems. Alternatively, or additionally, one or more components of the data conversion system 100 may be distributed. For example, the conversion module 105 may be disposed in a cloud computing device and the storage device 115 may be a local device.

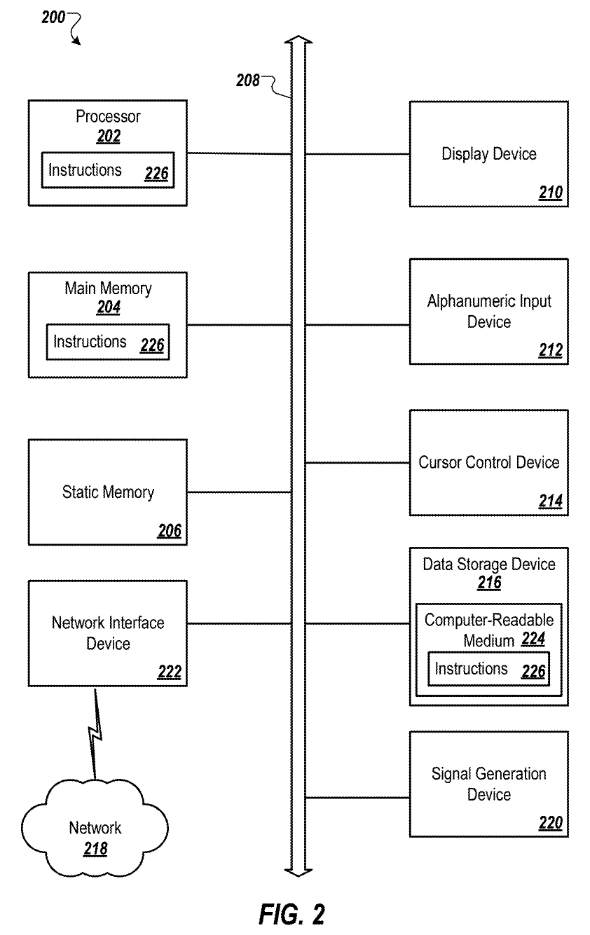

FIG. 2 illustrates an example computing device 200 within which a set of instructions for causing the machine to perform any one or more of the methods discussed herein may be executed. The computing device 200 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions for causing the machine to perform any one or more of the methods discussed herein may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 200 can include a processing device 202 (e.g., a processor), a main memory 204 (e.g., read-only memory (ROM), flash memory, dynamic random access memory (DRAM) such as synchronous DRAM (SDRAM)), a static memory 206 (e.g., flash memory, static random access memory (SRAM)) and a data storage device 115216, which communicate with each other via a bus 208.

The processing device 202 represents one or more general-purpose processing devices such as a microprocessor, central processing unit, or the like. More particularly, the processing device 202 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 202 may also include one or more special-purpose processing devices such as an application specific integrated circuit (ASIC), a field programmable gate array (FPGA), a digital signal processor (DSP), network processor, or the like. The processing device 202 is configured to execute instructions 226 for performing the operations and steps discussed herein.

The computing device 200 may further include a network interface device 222 which may communicate with a network 218. The computing device 200 also may include a display device 210 (e.g., a liquid crystal display (LCD) or a cathode ray tube (CRT)), an alphanumeric input device 212 (e.g., a keyboard), a cursor control device 214 (e.g., a mouse) and a signal generation device 220 (e.g., a speaker). In at least one implementation, the display device 210, the alphanumeric input device 212, and the cursor control device 214 may be combined into a single component or device (e.g., an LCD touch screen).

The data storage device 216 may include a computer-readable storage medium 224 on which is stored one or more sets of instructions 226 embodying any one or more of the methods or functions described herein. The instructions 226 may also reside, completely or at least partially, within the main memory 204 and/or within the processing device 202 during execution thereof by the computing device 200, the main memory 204 and the processing device 202 also constituting computer-readable media. The instructions may further be transmitted or received over a network 218 via the network interface device 222.

While the computer-readable storage medium 224 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding, or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. A method, comprising:
obtaining, via a user interface, data from a user, the data being associated with a first format;
converting, using a conversion module, the data having the first format to standardized data having a second format, wherein the conversion module is trained using a first instruction set associated with the data and a second instruction set associated with the second format;
comparing the standardized data to requirements included in the second instruction set; and
in response to detecting a difference between the standardized data and the requirements in the second instruction set, transmitting, via the user interface, a notification to the user, wherein the notification includes at least a description of the difference and a recommendation of a solution to the difference.

2. The method of claim 1, wherein obtaining the data comprises receiving the data through an application programming interface (API) that bypasses at least a portion of the user interface.

3. The method of claim 1, wherein obtaining the data comprises receiving the data via a remote procedure call (RPC) protocol.

4. The method of claim 1, wherein at least one of the first instruction set or the second instruction set is provided in a file format comprising portable document format (PDF), JavaScript Object Notation (JSON), comma-separated values (CSV), and a word-processing document format.

5. The method of claim 1, wherein at least one of the first instruction set or the second instruction set defines a delimiter used to separate elements within the data or values within an element of the data.

6. The method of claim 1, wherein the first instruction set specifies at least one of required data fields, optional data fields, expected ranges of values, data types, and an arrangement of data types.

7. The method of claim 1, wherein converting comprises identifying elements within the data and a format of the elements based at least in part on the first instruction set.

8. The method of claim 1, wherein the conversion module utilizes one or more large language models (LLMs) to read at least one of the first instruction set or the second instruction set.

9. The method of claim 8, wherein the conversion module utilizes the one or more LLMs to ingest information associated with at least one of the data or the first instruction set and the second instruction set.

10. The method of claim 1, wherein the first instruction set is associated with a first financial institution and the second instruction set is associated with a second financial institution.

11. The method of claim 1, wherein the recommendation of the solution comprises a suggested edit to the standardized data, and the method further comprises receiving a user confirmation via the user interface and, responsive to the user confirmation, implementing the suggested edit.

12. The method of claim 1, further comprising automatically updating previously converted standardized data in response to an update of the second instruction set.

13. The method of claim 12, wherein automatically updating comprises executing a versioned schema change command to modify the previously converted standardized data to conform to the update of the second instruction set.

14. The method of claim 12, further comprising:
detecting that the update has occurred; and
presenting, via the user interface, an option to update the previously converted standardized data, wherein the updating is performed in response to receiving a user confirmation.

15. A computing system, comprising:
a processor; and
a memory storing instructions that, when executed by the processor, cause the computing system to:
obtain, via a user interface, data from a user, the data being associated with a first format;
convert, using a conversion module, the data having the first format to standardized data having a second format, wherein the conversion module is trained using a first instruction set associated with the data and a second instruction set associated with the second format;
compare the standardized data to requirements included in the second instruction set; and
in response to detecting a difference between the standardized data and the requirements in the second instruction set, transmit, via the user interface, a notification to the user, wherein the notification includes at least a description of the difference and a recommendation of a solution to the difference.

16. The computing system of claim 15, wherein obtaining the data comprises receiving the data through an application programming interface (API) that bypasses at least a portion of the user interface.

17. The computing system of claim 15, wherein obtaining the data comprises receiving the data via a remote procedure call (RPC) protocol.

18. The computing system of claim 15, wherein the first instruction set specifies at least one of required data fields, optional data fields, expected ranges of values, data types, and an arrangement of data types.

19. The computing system of claim 15, wherein:
the conversion module utilizes one or more LLMs to read at least one of the first instruction set or the second instruction set; and
the conversion module utilizes the one or more LLMs to ingest information associated with at least one of the data or the first instruction set and the second instruction set.

20. The computing system of claim 15, wherein the recommendation of the solution comprises a suggested edit to the standardized data, and further comprises receive a user confirmation via the user interface and, responsive to the user confirmation, implement the suggested edit.
